(19) United States
(12) Patent Application Publication
(10) Pub. No.: US 2024/0092661 A1
(43) Pub. Date: Mar. 21, 2024

(54) DISINFECTION OF WATER USING PULSED ELECTRIC FIELDS

(71) Applicant: Kohler Co., Kohler, WI (US)

(72) Inventors: Jason Kwacz, Kohler, WI (US); Yachna Garg, Gurgaon (IN)

(21) Appl. No.: 18/244,036

(22) Filed: Sep. 8, 2023

Related U.S. Application Data
(60) Provisional application No. 63/407,778, filed on Sep. 19, 2022.

(51) Int. Cl. C02F 1/48; C02F 1/00; E03C 1/02

(52) U.S. Cl. CPC C02F 1/487; C02F 1/008; E03C 1/02; C02F 2209/001; C02F 2209/11; C02F 2209/40; C02F 2301/043; C02F 2303/04; C02F 2307/06

(57) ABSTRACT

Provided is an apparatus for disinfecting water using a pulsed electric field, the apparatus including a chamber configured to direct a flow of water, a sensor disposed in the chamber configured to detect a quantity of particles and/or microorganisms in the flow of water, and an electric field generator including a pair of electrodes disposed in the chamber and a controller. The controller is configured to initiate generation of the electromagnetic filed in response to the detected quantity of microorganisms exceeding a predetermined threshold.

This application claims priority benefit of Provisional Application No. 63/407,778 (Docket No. 10222-22034A) filed Sep. 19, 2022, which is hereby incorporated by reference in its entirety.

### FIELD

The present disclosure relates to systems, methods, and apparatuses for using pulsed electric fields to disinfect water. More specifically, the present disclosure relates to systems, methods, and apparatuses for detecting a quantity of microorganisms in water and disinfecting the water using a pulsed electric field.

### BACKGROUND

Access to clean water is an essential human need. Primarily, clean water is needed for drinking; however, clean water is also necessary for bathing (i.e., washing). Water contaminated with pathogens or microorganisms may cause an individual using the contaminated water to become ill as a result of the pathogens or microorganisms ingested during consumption and/or washing. Even when water has undergone treatment at a water treatment facility, there is a possibility that the water has become contaminated with one or more pathogens as it has traveled through the water distribution system to a point of use. Traditional methods of disinfecting water, such as through the use of chemicals and/or ultraviolet (UV) light have undesirable consequences. For example, the use of chemicals, such as chlorine, to disinfect water may lead to a build up or increase in the quantity of chemicals in a water supply over time and/or combine with naturally occurring organic matter creating harmful byproducts. As another example, there are high energy costs required to use UV light to disinfect water. Accordingly, there is a need for apparatuses, systems, and methods for detecting a presence or quantity of pathogens or microorganisms in water and disinfecting the water using pulsed electric fields.

### BRIEF DESCRIPTION OF THE DRAWINGS

Exemplary embodiments of the present disclosure are described herein with reference to the following drawings, according to an exemplary embodiment.

FIG. 1 illustrates an electric field generator according to an exemplary embodiment of the present disclosure.

FIG. 2 illustrates an apparatus for disinfecting water using pulsed electric fields according to an exemplary embodiment of the present disclosure.

FIG. 3 illustrates a system for disinfecting water using pulsed electric fields according to an exemplary embodiment of the present disclosure.

FIG. 4 illustrates a system for disinfecting water using pulsed electric fields according to another embodiment of the present disclosure.

FIG. 5 illustrates a first cross-sectional view of a pair of electrodes according to an exemplary embodiment of the present disclosure.

FIG. 6 illustrates a second cross-sectional view of the pair of electrodes of FIG. 5 according to an exemplary embodiment of the present disclosure.

FIG. 7 illustrates a first cross-sectional view of a pair of electrodes according to another exemplary embodiment of the present disclosure.

FIG. 8 illustrates a second cross-sectional view of the pair of electrodes of FIG. 7 according to another exemplary embodiment of the present disclosure.

FIG. 9 illustrates a first cross-sectional view of a pair of electrodes according to yet another exemplary embodiment of the present disclosure.

FIG. 10 illustrates a cross-sectional view of the pair of electrodes of FIG. 9 according to yet another exemplary embodiment of the present disclosure.

FIG. 11 illustrates a system for disinfecting water in which water flows through an electric field generator.

FIG. 12 illustrates a system for disinfecting water in which water flows through a bypass channel and not an electric field generator.

FIG. 13 illustrates a system for disinfecting water in a state in which the electrodes of the electric field generator may be washed.

FIG. 14 illustrates a diagram for an electric field generator according to an exemplary embodiment of the present disclosure.

FIG. 15 illustrates a flow chart for an electric field generator according to an exemplary embodiment of the present disclosure.

FIG. 16 illustrates a flow chart illustrating for disinfecting water using an electric field generator according to an exemplary embodiment of the present disclosure.

FIG. 17 illustrates an apparatus for disinfecting water using pulsed electric fields according to an exemplary embodiment of the present disclosure.

The figures illustrate certain exemplary embodiments of the present disclosure in detail. It should be understood that the present disclosure is not limited to the details and methodology set forth in the detailed description or illustrated in the figures. It should be understood that the terminology used herein is for the purpose of description only and should not be regarded as limiting.

### DETAILED DESCRIPTION

Described herein are apparatuses, systems, and methods for detecting the presence of microorganisms in a flow or supply of water and for disinfecting the water using pulsed electric fields. The apparatuses, systems, and methods disclosed herein may be implemented for localized detection of microorganisms and disinfection of water. For example, the apparatuses and systems disclosed herein may be implemented at a building level (i.e., effecting the entire water supply into a commercial or residential building). In other examples, the apparatuses and systems disclosed herein may be implemented so as to affect the water supply for only a single room or a single fixture within the building.

The apparatuses and systems disclosed herein include an electric field generator configured to generate an electromagnetic field in a plurality or series of pulses within a treatment chamber or channel. An electromagnetic field, when generated in a plurality of pulses, can be used to cause electroporation (e.g., formation of pores) of the cellular membrane of microorganisms, deactivating or killing the microorganisms. The electric field generator may apply an electromagnetic field generated via plurality of high-voltage pulses to a water supply in order to disinfect the water supply. An electromagnetic field generated in a series of high voltage pulses is a non-thermal method of microbial inactivation without affecting water quality.

The term “plumbing fixture” refers to an apparatus that is connected to a plumbing system of a house, building, or another structure. The term “plumbing fixture” may include faucets, showerheads, bathtubs, dishwashers, toilets, and bidets. The term “bathroom fixture” and “kitchen fixture” may more specifically refer to individual types of plumbing fixtures found in the bathroom or kitchen, respectively, and these terms may be overlapping in certain examples (e.g., faucets). While each of the apparatuses or systems for disinfecting water using pulsed electric fields described herein may be described as used in connection with or included in a single type of plumbing fixture, it should be understood that the present disclosure is not limited thereto and that each of the apparatuses or systems described herein may be included in or used in conjunction with any of a faucet, shower head, dishwasher, toilet, and the like.

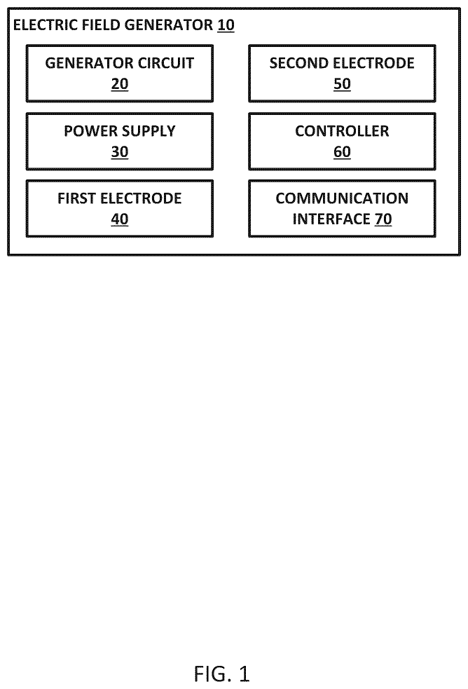

FIG. 1 illustrates an electric field generator 10 according to an exemplary embodiment of the present disclosure. The electric field generator 10 may include a generator circuit 20, a power supply 30, a first electrode 40, a second electrode 50, a controller 60, and a communication interface 70. The generator circuit 20 is connected to the first electrode 40, the second electrode 50, and the controller 60.

The generator circuit 20, first electrode 40, and second electrode 50 are configured to generate an electromagnetic field between the first electrode 40 and the second electrode 50. Specifically, the generator circuit 20, first electrode 40, and second electrode 50 are configured to generate an electromagnetic field occurring in (e.g., via, using) a series of pulses. In some examples, the first electrode 40 may comprise a cathode and the second electrode 50 may comprise an anode. The first electrode 40 and the second electrode 50 may be referred to collectively as a pair of electrodes. The generator circuit 20 may be configured to supply direct current to the first electrode 40 (cathode) causing an electric field to form between the first electrode 40 (cathode) and the second electrode 50 (anode) as the current flows from the first electrode 40 (cathode) to the second electrode 50 (anode). The generator circuit 20 may be configured to supply direct current to the first electrode 40 (cathode) at regular intervals (e.g., using or via a plurality or series of pulses), thus causing an electric field to be generated between the first electrode 40 (cathode) and the second electrode 50 (anode) at regular intervals (e.g., using or via a plurality or series of pulses). The generator circuit may be configured to supply current to the first electrode 40 (cathode) at regular intervals for a predetermined period of time, causing an electromagnetic field to be generated at regular intervals (e.g., via a plurality of pulses) for a predetermined period of time; and this may be referred to as a treatment cycle.

In some examples, the generator circuit 20 may be configured to supply current to the first electrode 40 (cathode) at irregular intervals and/or for varying periods of time, resulting in a plurality of electromagnetic pulses occurring at irregular intervals and/or pulses that persist for varying periods of time.

As described herein, the electric field generator 10 is configured to apply a high voltage electromagnetic field to a flow or supply of water. Accordingly, the first electrode 40 and the second electrode 50 may be spaced apart from one another such that a flow or supply of water is disposed between the first electrode 40 and the second electrode 50. Thus, when an electric field is generated between the first electrode 40 and the second electrode 50, the electromagnetic field is applied to the flow or supply of water and causes electric current to flow along the electric field lines through the flow or supply of water. When an electromagnetic field of an appropriate intensity or magnitude and duration is applied to flow or supply of water via a plurality or series of pulses (e.g., at regular intervals), the electromagnetic field may cause the formation of pores in the cellular membrane of microorganisms within the flow or supply of water. The appropriate intensity of the electric field, duration of the magnetic field, and interval between pulses of the electromagnetic field may be a function of a flow rate of water between the first electrode 40 and the second electrode 50. In some embodiments, the electric field generator 10 may include more than one pair of electrodes (e.g., a plurality of electrode pairs).

The electric field generator 10 may further include a controller 60. The controller 60 may be configured to initiate or start a treatment cycle. In some examples, the controller 60 may initiate a treatment cycle by sending a start command to the generator circuit 20. In other examples, the controller 60 may initiate a treatment cycle by selectively allowing a flow of current to the generator circuit 20. In some examples, the controller 60 may include a clock and may be configured to initiate a treatment cycle periodically after a predetermined interval of time.

The electric field generator 10 may further include a communication interface 70. The communication interface 70 may be connected to the internet and/or other networks. The internet and/or other networks may be in communication with one or more mobile devices. The communication interface may receive one or more commands from the one or more mobile devices via the internet and/or other networks. The one or more commands include, for example, a command to initiate a treatment cycle, a command to initiate an operating mode in which a treatment cycle is initiated periodically after a predetermined period of time, a command to terminate or end a mode in which a treatment cycle is initiated periodically after a predetermined period of time, and the like. The one or more commands may further include a command to set or adjust an intensity of the electric field, a duration of the magnetic field, and/or an interval between pulses of the electromagnetic field.

The electric field generator 10 may further include a power supply 30 connected to the generator circuit 20. The power supply 30 may be configured to supply power to the generator circuit 20. In some examples, the power supply may be configured to supply direct current to the generator circuit 20. In some examples, the power supply 30 may be a battery or fuel cell. In other examples, the power supply 30 may be a building power supply (e.g., a wall outlet) and a transformer and rectifier may be used to convert the alternating current into direct current.

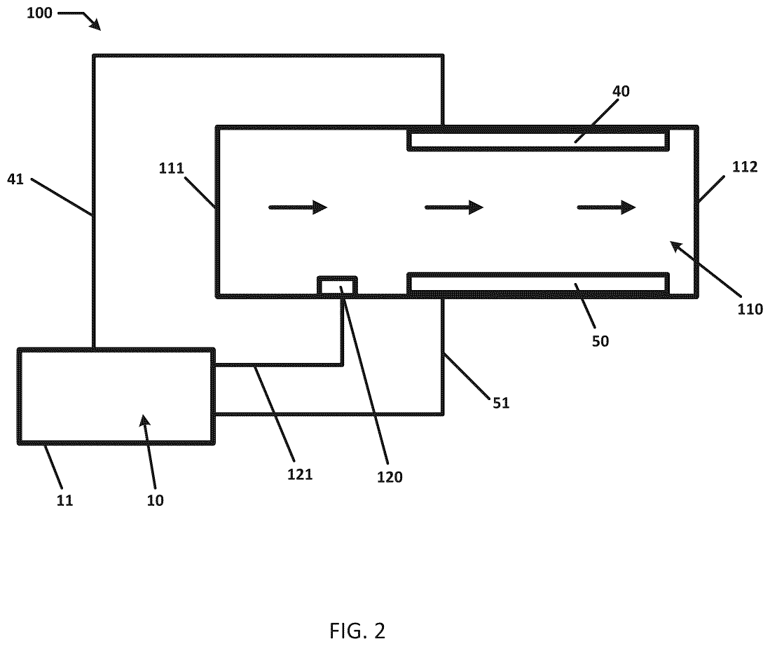

FIG. 2 illustrates an apparatus 100 for disinfecting water using pulsed electric fields according to an exemplary embodiment of the present disclosure. The apparatus 100 may include an electric field generator 10, a chamber 110, a sensor 120. As illustrated in FIG. 1, the electric field generator 10 may have an enclosure 11. The enclosure 11 may include the generator circuit 20, the controller 60, and the communication interface 70. The first electrode 40 and the second electrode 50 may be disposed outside of the enclosure 11. The first electrode 40 and the second electrode 50 may be attached or coupled to the chamber 110. In some examples, the first electrode 40 and the second electrode 50 may be disposed within the chamber 110. In other examples, the first electrode 40 and the second electrode 50 may be disposed adjacent to the chamber 110. For example, the first electrode 40 and the second electrode 50 may be disposed adjacent to the chamber 110 such that a surface of the first electrode 40 and/or a surface of the second electrode 50 are coextensive with an inner surface of the chamber 110. The first electrode 40 and the second electrode 50 may be attached to the chamber 110 so as to be across from one another. The apparatus 100 may further include a first wire 41 connecting the first electrode 40 to the generator circuit 20 and a second wire 51 connecting the second electrode 50 to the generator circuit 20.

The chamber 110 is configured to contain and direct a flow of water. In some examples, the chamber 110 may have a hollow cylindrical (e.g., pipe) shape. In other examples, the chamber 110 may have a hollow rectangular shape. In some examples, the chamber 110 may be a portion or a segment of a water distribution conduit within a building (e.g., residential, commercial). The chamber 110 may be disposed in a plumbing fixture, for example, a faucet, showerhead, bathtub, dishwasher, or the like. The chamber 110 may have two open ends (111, 112) disposed opposite of one another and the chamber 110 may be configured to direct a flow of water from a first open end 111 to a second open end 112. Each of the first open end 111 and the second open end 112 may be coupled to and in fluid communication with a water distribution conduit within a residential or commercial building. Each of the first open end 111 and the second open end 112 may be coupled to a respective water distribution conduit so as to prevent water from leaking through the interface between the first open end 111 and a respective water distribution conduit and the second open end 112 and a respective water distribution conduit. In some examples, the chamber 110 may have a larger cross-sectional area in a direction perpendicular to a flow through the chamber the water distribution conduits attached to either end of the chamber. In other examples, the chamber 110 may have a smaller cross-sectional area in a direction perpendicular to a flow through the chamber the water distribution conduits attached to either end of the chamber. The chamber 110 is comprised of a non-conductive material. For example, the chamber 110 may be comprised of plastic, ceramic, glass, or the line. In some examples, the chamber 110 may be comprised of a plastic, such as polyvinyl chloride or the like.

The apparatus 100 further includes a sensor 120 attached or coupled to the chamber 110. In some examples, the sensor 120 may disposed within the chamber 110. In other examples, the sensor 120 may be disposed adjacent to the sensor. For example, the sensor 120 may be disposed adjacent to the chamber 110 such that a surface of the sensor 120 is coextensive with an inner surface of the chamber 110. In some examples, the sensor 120 is configured to detect the presence of and/or a quantity of particles within a flow of water in the chamber 110. In other examples, the sensor 120 is configured to detect the presence of and/or a quantity of microorganisms within a flow of water in the chamber 110.

In some examples, the sensor 120 may be a turbidity sensor. The turbidity sensor may include a light source configured to emit a beam of light into the chamber 110 and a detector configured to detect light. As the beam of light is radiated into the medium, here, a flow of water within the chamber 110, particles within the water may reflect or scatter portions of the beam of light. The detector is configured to detect the presence of light. In some embodiments, the detector may be at an angle relative to the light source and be configured to detect light reflected or scattered by one or more particles within the flow of water. In some examples, the detector may be located at an angle of 90 degrees relative to the light source (e.g., beam of light). In other examples, the detector may be located at an angle of 135 degrees relative to the light source. In some embodiments, the detector may be located in line with the light source and the detector may be configured to detect the beam of light instead of reflected or scattered light. In some embodiments, the turbidity sensor and/or controller 60 may determine the presence of microorganisms within the flow of water based on the pattern of reflected or scattered light detected or the pattern in a beam of light detected by a detector in line with the beam of light.

In other examples, the sensor 120 may be a camera. The camera may be configured to collect an image or video of the flow of water within the chamber 110. The camera and/or the controller 60 may be configured to perform image or video classification to detect the presence of and/or a quantity of particles in the flow of water. In some examples, the camera and/or the controller 60 may be configured to perform image or video classification to detect the presence of and/or a quantity of microorganisms in the flow of water. The results of the classification may indicate a type and/or quantity of particles and/or microorganisms in the water. One or more neural networks may be used to perform image and/or video classification of the flow of water within the chamber. In some examples, manual or crowdsourced identification of conditions may be used as ground truth for training the neural network.

The controller 60 of the electric field generator is configured to compare the quantity of particles and/or microorganisms detected by the sensor (i.e., detected quantity) to a predetermined threshold of particles and/or microorganisms. If the detected quantity of particles or microorganisms exceeds the predetermined threshold, the controller 60 may initiate a treatment cycle.

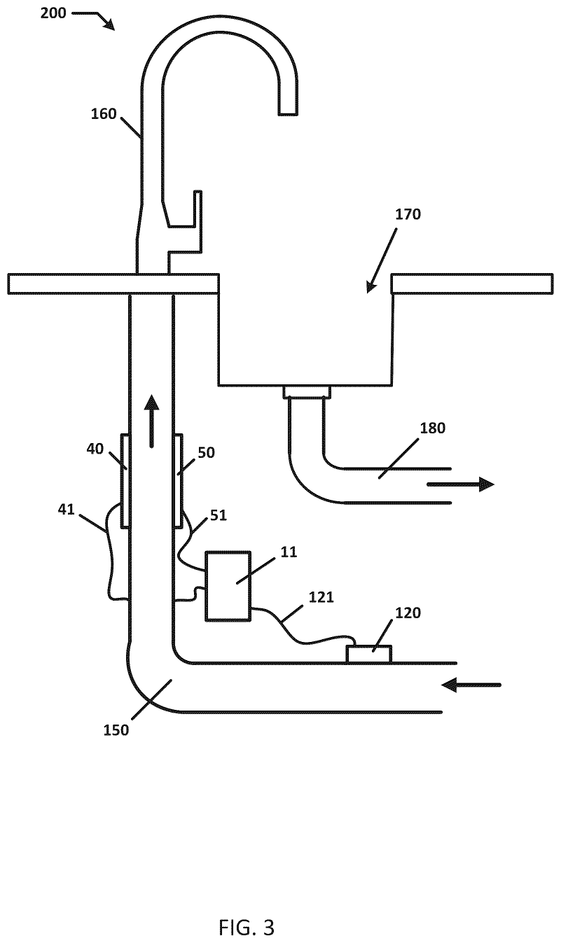

FIG. 3 illustrates a system 200 for disinfecting water using pulsed electric fields according to an exemplary embodiment of the present disclosure. As illustrated in FIG. 3, the system 200 includes an electric field generator 10, a sensor 120, a primary channel 150, a faucet 160, and a basin 170, and a drain channel 180. The electric field generator 10 and the sensor 120 may be the same as those discussed above with respect to FIGS. 1 and 2. The first electrode 40, second electrode 50, and sensor 120 may be disposed within or coupled to the primary channel 150.

The primary channel 150 may be configured to supply a flow of water to a water outlet device. In some examples, as illustrated in FIG. 3, the water outlet device may be faucet 160. In other examples, the primary channel 150 may be configured to supply a flow of water to a different water outlet device or plumbing fixture. For example, the water outlet device may be a showerhead, a toilet, or the like. The primary channel 150 may be a water a water distribution conduit or pipe within a building. The water channel 150 may be comprised of one or more sections or pieces of pipe or conduit coupled together (e.g., fluidly connected).

The system 200 may further include a basin 170 configured to receive the flow of water dispensed from the faucet 160 and a drain channel 180 fluidly connected to the basin 170 and configured to direct water dispensed into the basin to a drainpipe drain outlet.

As illustrated in FIG. 3, the sensor 120 is located upstream of the first electrode 40 and the second electrode 50 in the direction of a flow of water within the primary channel 150. As the flow of water passes the sensor 120, the sensor 120 collects sensor data (e.g., a light pattern, an image, a video, etc.) indicative of a quantity of particles and/or microorganisms within the flow of water. The sensor 120 is connected to the controller 60 of the electric field generator via a third wire 121. In other embodiments, the sensor 120 may communicate with the controller 60 wirelessly. For example, sensor 120 and the controller may communicate over one or more networks, such as the internet or another network. The controller 60 is configured to compare the sensor data to a predetermined threshold of particles and/or microorganisms. If the detected quantity of particles and/or microorganisms exceeds the predetermined threshold, the controller 60 may initiate or start a treatment cycle. During the treatment cycle the electric field generator 10 may generate an electric field between the first electrode 40 and the second electrode 50 via or in a series of pulses, disinfecting the flow of water as the flow of water travels between the first electrode 40 and the second electrode 50.

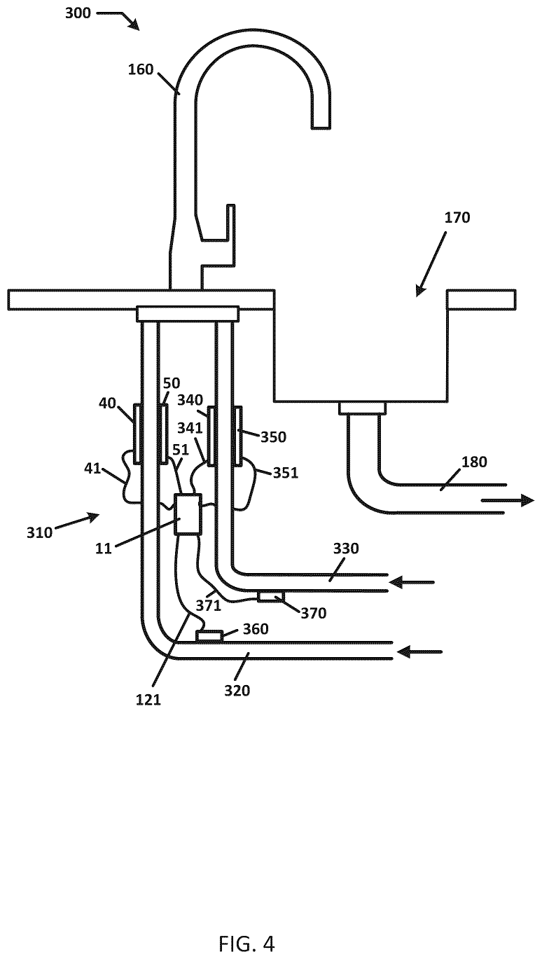

FIG. 4 illustrates a system 300 for disinfecting water using pulsed electric fields according to another embodiment of the present disclosure. The system 300 includes an electric field generator 310, a first channel 320, a second channel 330, a first sensor 360, a second sensor 370, a first electrode 40, a second electrode 50, a third electrode 340, and a fourth electrode 350. The system 300 may further include a faucet 160, a basin 170, and a drain channel 180.

The system 300 includes a first channel 320 and a second channel 330. The first channel 320 and the second channel 330 may both be fluidly connected to a water outlet device, for example, the faucet 160. One of the first channel 320 and the second channel 330 may be a hot water supply and the other of the first channel 320 and the second channel 330 may be a cold water supply. Each of the first channel 320 and the second channel 330 may be the same as the primary channel 150 as described above with respect to FIG. 2.

The system 300 includes two pairs of electrodes. The first electrode and the second electrode 50 comprise the first pair of electrodes and are configured to generate an electromagnetic field within the first channel 320. The third electrode 340 and the fourth electrode 350 comprise the second electrode pair 350 and are configured to generate an electromagnetic field in the second channel 330. The third electrode 340 and the fourth electrode 350 may be the same as the first electrode 40 and the second electrode 50, respectively. One of the third electrode 340 and the fourth electrode 350 comprises a cathode and the other of the third electrode 340 and the fourth electrode 350 comprises an anode.

The first electrode pair (first electrode 40 and second electrode 50) may be coupled to and/or disposed within the first channel 320. The first electrode 40 may include a first wire 41 connecting the first electrode 40 to the generator circuit 20 of the electric field generator 10. The second electrode 50 may include a second wire 51 connecting the second electrode 51 to the generator circuit 20 of the electric field generator 10.

The second electrode pair (third electrode 340 and fourth electrode 350) may be coupled to and/or disposed within the second channel 330. The third electrode 340 may include a fourth wire 341 connecting the third electrode 340 to the generator circuit 20 of the electric field generator 10. The fourth electrode 350 may include a fifth wire 351 connecting the fourth electrode 350 to the generator circuit 20 of the electric field generator.

The first sensor 360 may be coupled and/or disposed within the first channel 320. The first sensor 120 may be the same as the sensor 120 described above with respect to FIG. 2. The first sensor 360 is configured to detect a presence and/or quantity of particles and/or microorganisms (i.e., a first detected quantity) in a flow of water in the first channel 320. In some examples, the first sensor 360 is connected to the controller 60 of the electric field generator 10 using a third wire 121. In other examples, the first sensor 360 and the controller 60 may communicate with one another wirelessly. For example, the first sensor 360 and the controller 60 may communicate with each other using one or more networks. For example, the first sensor 360 may communicate with the controller 60 using the internet or another network.

The second sensor 370 may be coupled to and/or disposed within the second channel 330. The second sensor 370 may be the same as the sensor 120 described above with respect to FIG. 2. The second sensor 370 is configured to detect a presence of and/or a quantity of particles and/or microorganisms (i.e., a second detected quantity) in a flow of water in the second channel 330. In some examples, the second sensor 370 is connected to the controller 60 of the electric field generator 10 using a sixth wire 371. In other examples, the second sensor 370 and the controller 60 may communicate with one another wirelessly. For example, the second sensor 370 and the controller 60 may communicate with each other using one or more networks. For example, the second sensor 370 may communicate with the controller 60 using the internet or another network.

The controller 60 of the electric field generator 10 is configured to receive a first detected quantity of particles and/or microorganisms from the first sensor 360 and a second detected quantity of particles and/or microorganisms from the second sensor 370. The controller 60 is configured to compare the first detected quantity of particles and/or microorganisms to a predetermined threshold. If the first detected quantity of particles and/or microorganisms exceeds the predetermined threshold, the controller 60 is configured to initiate a treatment cycle in the first channel 320 (i.e., generate an electromagnetic field in the first channel via a plurality of pulses using the first electrode 40 and the second electrode 50). The controller 60 is further configured to compare the second detected quantity of particles and/or microorganisms to the predetermined threshold. If the second detected quantity of particles and/or microorganisms exceeds the predetermined threshold, the controller 60 is configured to initiate a treatment cycle in the second channel 330 (i.e., generate an electromagnetic field in the second channel 330 via a plurality of pulses using the third electrode 340 and the fourth electrode 350).

In some examples, the generator circuit 20 may include four or more switches configured to selectively connect the first electrode 40, second electrode 50, third electrode 340, and fourth electrode 350 to the generator circuit 20. In some examples, a portion of the first channel 320, a portion of the second channel 330, the first sensor 360, the second sensor 370, and the electric field generator 10 are disposed within a housing.

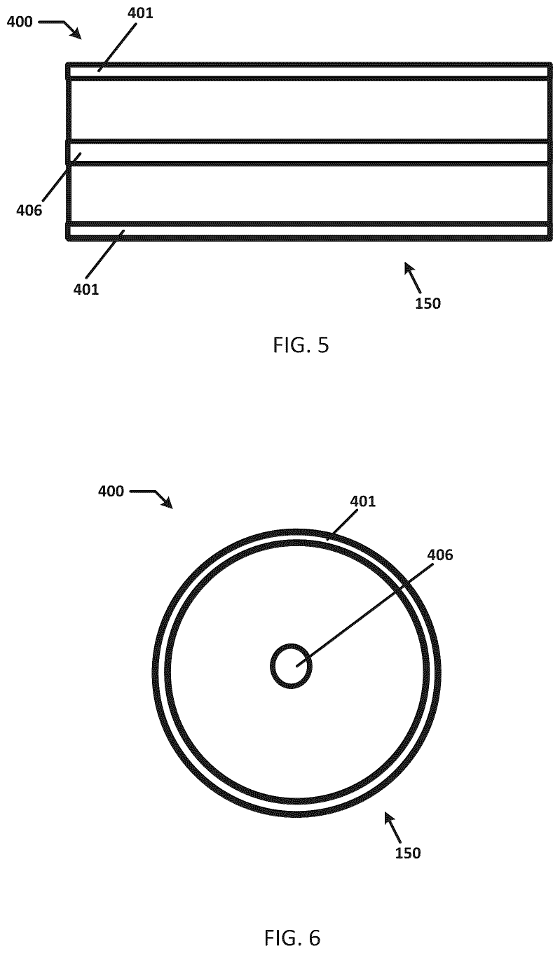

FIGS. 5 and 6 illustrate a pair of electrodes 400 according to an embodiment of the present disclosure. FIG. 5 illustrates a cross-sectional view of the pair of electrodes 400 perpendicular to a direction of flow of water. FIG. 6 illustrates a cross-sectional view of the pair of electrodes of FIG. 5 taken along a direction of flow of water. The pair of electrodes 400 illustrated in FIGS. 5 and 6 include a first electrode 401 and a second electrode 406. The pair of electrodes (401 and 406) may be coupled to and/or disposed within a chamber 110 as described with respect to FIG. 1, a primary channel as described above with respect to FIG. 2, a first channel 320 as described above with respect to FIG. 4 and/or a second channel 330 described above with respect to FIG. 4. For ease of explanation, the first electrode 401 and the second electrode 406 are described below as being coupled to and/or disposed within a primary channel 150.

As illustrated in FIGS. 5 and 6, the first electrode 401 may be coupled or attached to an inner surface of the primary channel 150. The first electrode 401 may cover or line an inner surface of the primary channel 150. The second electrode 406 may be disposed within the primary channel 150 along a central axis of the primary channel. Accordingly, an electromagnetic filed may be generated between the first electrode 401 and the second electrode 406.

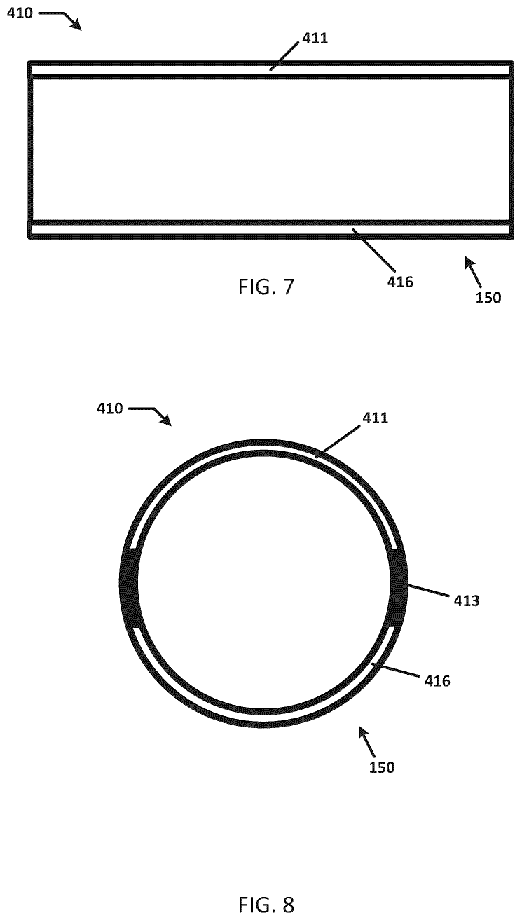

FIGS. 7 and 8 illustrate a pair of electrodes 410 according to an embodiment of the present disclosure. FIG. 7 illustrates a cross-sectional view of the pair of electrodes 410 perpendicular to a direction of flow of water. FIG. 8 illustrates a cross-sectional view of the pair of electrodes 410 of FIG. 7 taken along a direction of flow of water. The pair of electrodes 410 illustrated in FIGS. 7 and 8 include a first electrode 411 and a second electrode 416. The pair of electrodes (411 and 416) may be coupled to and/or disposed within a chamber 110 as described with respect to FIG. 1, a primary channel as described above with respect to FIG. 2, a first channel 320 as described above with respect to FIG. 4 and/or a second channel 330 described above with respect to FIG. 4. For ease of explanation, the first electrode 411 and the second electrode 416 are described below as being coupled to and/or disposed within a primary channel 150.

As illustrated in FIGS. 7 and 8, the first electrode 411 may be disposed within the primary channel 150 along a portion of the inner surface of the primary channel 150. The second electrode 416 may be disposed within the primary channel 150 along a different portion of the inner surface of the primary channel 150. A spacer 413 comprising a nonconductive material may be disposed between the first electrode 411 and the second electrode 416. Accordingly, an electromagnetic field may be generated between the first electrode 411 and the second electrode 416.

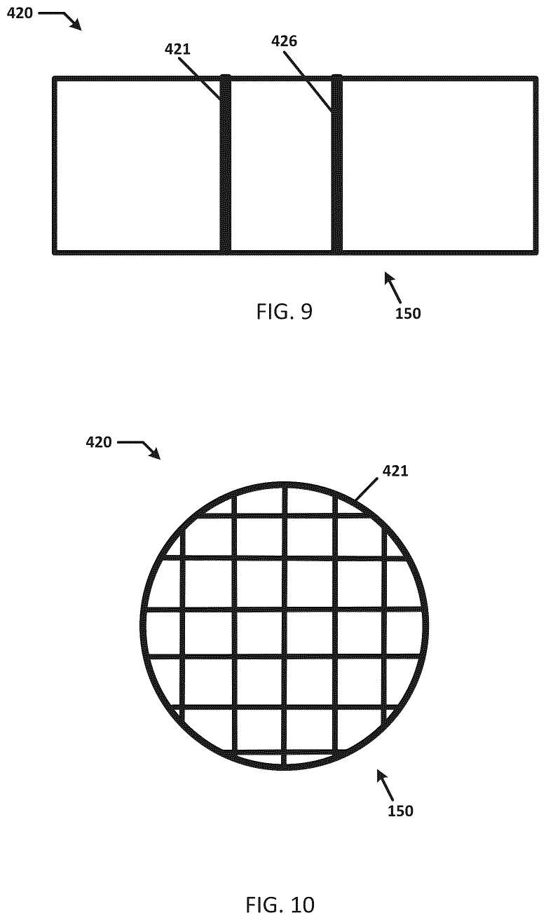

FIGS. 9 and 10 illustrate a pair of electrodes 420 according to an embodiment of the present disclosure. FIG. 9 illustrates a cross-sectional view of the pair of electrodes 420 perpendicular to a direction of flow of water. FIG. 10 illustrates a cross-sectional view of the pair of electrodes 420 of FIG. 9 taken along a direction of flow of water. The pair of electrodes 420 illustrated in FIGS. 9 and 10 include a first electrode 421 and a second electrode 426. The pair of electrodes (421 and 426) may be coupled to and/or disposed within a chamber 110 as described with respect to FIG. 2, a primary channel as described above with respect to FIG. 3, a first channel 320 as described above with respect to FIG. 4 and/or a second channel 330 described above with respect to FIG. 4. For ease of explanation, the first electrode 421 and the second electrode 426 are described below as being coupled to and/or disposed within a primary channel 150.

As illustrated in FIGS. 9 and 10, the first electrode 421 and the second electrode 426 may be spaced apart from one another in a direction of flow through the primary channel 150. The first electrode 421 and the second electrode 426 may have the same shape. The first electrode 421 and second electrode may have the lattice shape illustrated in FIG. 10. The lattice shape allows water to flow through the first electrode 421 and the second electrode 426. An electromagnetic field may be generated between the first electrode 421 and the second electrode 426.

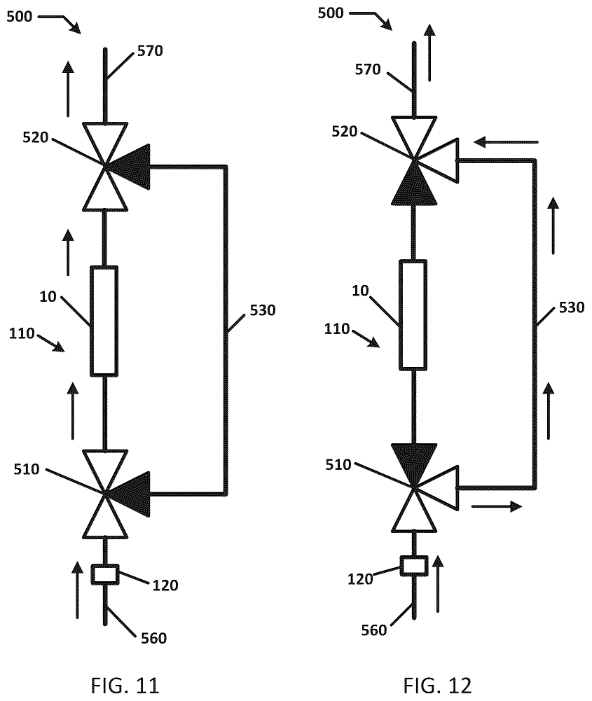

FIGS. 11 and 12 illustrate a system 500 for disinfecting water. The system 500 includes a first valve 510, a second valve 520, an electric field generator 10, and a bypass channel or bypass conduit 530. The first valve 510, second valve 520, and electric field generator may be coupled to a chamber 110 as described above with respect to FIG. 2, a primary channel 150 as described above with respect to FIG. 3, a first channel 320 as described above with respect to FIG. 4, and/or a second channel 330 as described above with respect to FIG. 5. For ease of explanation, the system 500 will be described below as coupled to a chamber 110.

The first valve 510 is coupled (e.g., fluidly connected) to a first water distribution conduit 560, the chamber 110, and a bypass conduit 530. The first water distribution conduit 560 is configured to supply a flow of water to the first valve 510. The first valve 510 is operable to divert the flow of water supplied or directed by the first water distribution conduit 560 between the chamber 110 and the bypass conduit 530. The first valve 510 may be a three-way valve, for example, a three-way ball valve. In some embodiments, an actuator (e.g., solenoid) may be configured to change a position or orientation of the first valve 510. In some examples, the actuator may be in communication with the controller 60 of the electric field generator 10 and the controller 60 may send a signal or selectively supply power to the actuator causing the actuator to change a position or orientation of the first valve 510. In some examples, the controller 60 may be configured to control an opening degree of the first valve 510. The controller 60 may be configured to send a signal or supply power to the actuator causing the first valve 510 to open to a specific amount or degree. The flow rate and/or quantity of water flowing through the first valve 510 and into the chamber 110 may be controlled by controlling an opening degree of the first valve 510.

The second valve 520 is coupled to the chamber 110, the bypass conduit 530 and a second water distribution conduit 570 or a water outlet device. The second valve 510 is configured to supply water to the second water distribution conduit 570 or water outlet device. The second valve 520 is operable to receive water from either the chamber 110 or the bypass conduit 530. The second valve 520 may be a three-way valve, for example, the second valve 520 may be a three-way ball valve. In some examples, an actuator (e.g., solenoid) may be configured to change a position or orientation of the second valve 520. In some examples, the actuator may be in communication with the controller 60 of the electric field generator 10 and the controller 60 may send a signal or selectively supply power to the actuator causing the actuator to change a position or orientation of the first valve 520.

In some embodiments, the system 500 may further include sensor 120. The sensor 120 may be coupled to and/or disposed within the first water distribution conduit 560. The sensor 120 may be disposed upstream in the direction of flow of the water of the first valve 510. The sensor 120 may be in communication with the controller 60 of the electric field generator 10. The controller 60 may be configured to actuate the first valve 510 and/or the second valve in response to the sensor data collected by the sensor 120.

FIG. 11 illustrates the system 500 in a state in which water flows from the first water distribution conduit 560 through the first valve 510 and into the chamber 110, through the chamber 110 and into the second valve 520, through the second valve 520 and into the second water distribution conduit 570 or water outlet device. As illustrated in FIG. 11, the first valve 510 receives a flow water from the first water distribution channel and directs or supplies the flow of water to the chamber 110. Further, the second valve 520 receives the flow of water from the chamber 110 and directs or supplies the water to the second water distribution conduit 570 or a water outlet device.

The state or orientation of the first valve 510 and the second valve 520 as illustrated in FIG. 11 may be used when a water treatment cycle is occurring (e.g., when the electric field generator 10 is generating electromagnetic pulses in the chamber 110). In some examples, the valve orientations illustrated in FIG. 11 may be used for a period of time before a treatment cycle is initiated. In some examples, when the controller 60 of the electric field generator 10 determines that a detected quantity (e.g., by sensor 120) of particles and/or microorganisms exceeds a predetermined threshold, the controller 60 may cause the first valve 510 and the second valve 520 to actuate to their respective orientations illustrated in FIG. 11. After causing the first valve 510 and the second valve 520 to actuate the orientations illustrated in FIG. 11, the controller 60 may initiate a treatment cycle.

FIG. 12 illustrates the system 500 in a state in which the water flows from the first water distribution conduit 560 through the first valve 510 into the bypass conduit 530, through the bypass conduit 530 and into the second valve 520, through the second valve 520 and into the second water distribution conduit 570 or water outlet device. As illustrated in FIG. 12 the first valve 510 receives a flow of water from the first water distribution conduit 560 and directs or supplies the flow of water to the water bypass conduit 530. Further, the second valve 520 receives the flow of water from bypass conduit 530 and directs or supplies the flow of water to the second water distribution conduit 570 or water outlet device. The valve orientation of FIG. 11 may be used when a water treatment cycle is not occurring and/or not about to occur. Specifically, when the controller 60 determines that a detected quantity of particles and/or microorganisms does not exceed the predetermined threshold, the controller 60 may cause the first valve 510 and the second valve 520 to actuate to their respective orientations illustrated in FIG. 12.

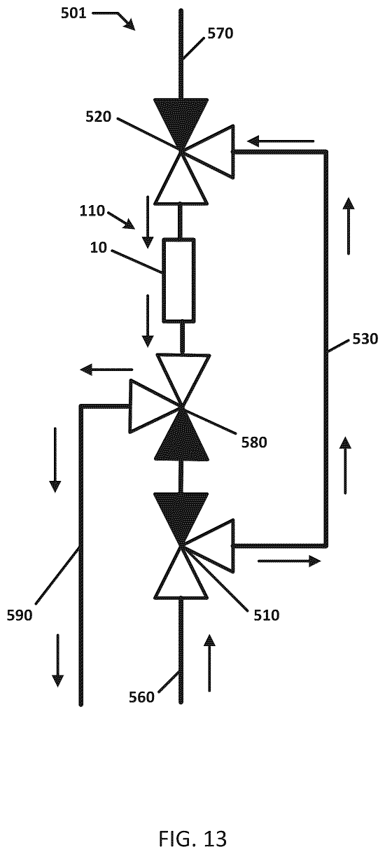

FIG. 13 illustrates a system 501 for disinfecting water in a state in which the electrodes of the electric field generator may be washed. The system 501 includes a first valve 510, a second valve 520, an electric field generator 10, a bypass channel or a bypass conduit 530, and a third valve 580. The first valve 510, second valve 520, electric field generator 10, and third valve 580 may be coupled to a chamber 110 as described above with respect to FIG. 2, a primary channel 150 as described above with respect to FIG. 3, a first channel 320 as described above with respect to FIG. 4, and/or a second channel 330 as described above with respect to FIG. 5. For ease of explanation, the system 500 will be described below as coupled to a chamber 110.

As illustrated in FIG. 13, a flow of water may flow through the first water distribution conduit 560 into the first valve 510. The flow of water may flow through the first valve 510 to the water bypass conduit 530. The flow of water may flow through the bypass conduit 530 into the second valve 520. The flow of water may flow through the second valve 520 into the chamber 110. The flow of water may flow through the chamber 110 to the third valve 580. The flow of water may flow through the third valve 580 and into the backflow channel 590.

The flow path as illustrated in FIG. 13 and describe above may be used to wash the electrodes (e.g., first electrode 40 and second electrode 50) of the electric field generator 10 as the water flows from the second valve 520 through the chamber 110 and to the third valve 580. The electrodes (e.g., 40, 50) may be washed as apart of routine maintenance of the electric field generator. The electrodes may be washed to remove a build up or accumulation on the electrodes. For example, the electrodes may be washed to remove an accumulation of scale (e.g., soil or metal deposits from the water supply). In some examples, the chamber 110, sensor 120, electric field generator 10, first valve 510, second valve 520, bypass conduit 530, and third valve 580 are all disposed within a housing.

The system 501 is additionally configured to allow a flow of water to flow through the chamber 110 to the second water distribution conduit 570 or water outlet device. For example, the system 501 may allow a flow of water to flow through the first water distribution conduit 560 into the first valve 510, through the first valve 510 to the third valve 580, through the third valve 580 and into the chamber 110, through the chamber 110 and into the second valve 520, through the second valve 520 and into the second water distribution conduit 570 or water outlet device when a water treatment cycle is occurring or about to occur. The third valve 580 may be located between a portion of the chamber 110 including the first electrode 40 and the second electrode 50 and the first valve 510. The third valve 580 may be a three-way valve, for example, a three-way ball valve.

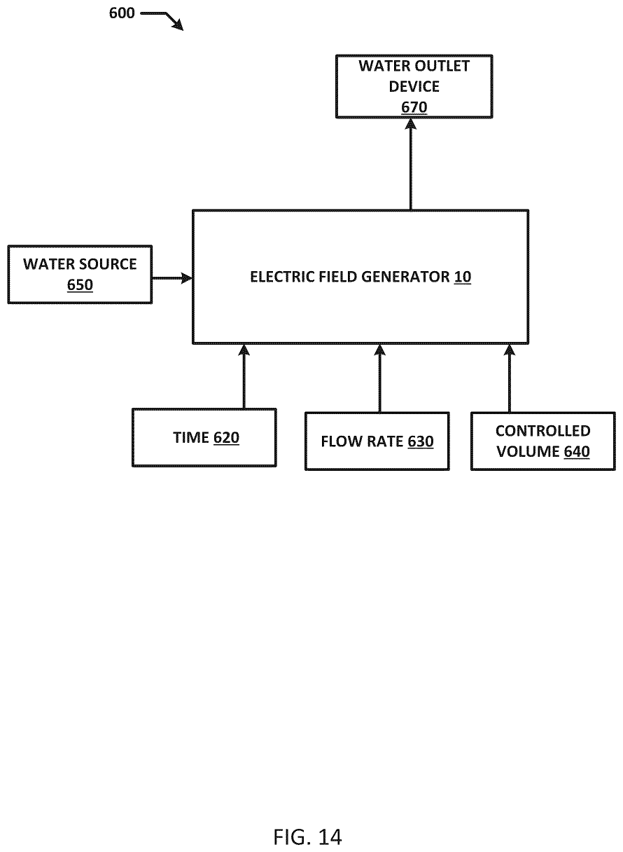

FIG. 14 illustrates a diagram 600 for an electric field generator according to an exemplary embodiment of the present disclosure. As illustrated in the diagram 600, the electric field generator 10 receives water (e.g., a flow of water) from a water source 650. The electric field generator 10 may receive a flow of water from a water distribution conduit in fluid communication with a chamber (e.g., chamber 110) or channel (e.g., primary channel 150, first channel 320, second channel 330). As illustrated, the electric field generator 10, specifically the controller 60, may receive a flow rate 630 and/or a volume of water 640 supplied to the electric field generator 10. In some examples, the electric field generator 10 may control a frequency, duration, and/or magnitude of the plurality of electromagnetic pulses generated during a treatment cycle according to the flow rate 630 and/or volume 640 of water supplied to the electric field generator 10. In other examples, a volume 640 and/or flow rate 630 of water supplied to the electric field generator 10 may be controlled by a valve (e.g., first valve 510), such that a flow rate and/or volume of water capable of being disinfected by the electric field generator 10 is supplied to the electric field generator. The electric field generator 10 may also receive the time 620. In some examples, the electric field generator may include a clock. In other examples, another device may provide a time to the electric field generator 10. The electric filed generator 10 may use the time 620 to determine if a predetermined interval of time has passed since the last treatment cycle and initiate a treatment cycle if a time period longer than the predetermined period of time has passed since the last treatment cycle. The electric field generator 10 is configured to supply a flow of water to a second water distribution conduit or a water outlet device 670.

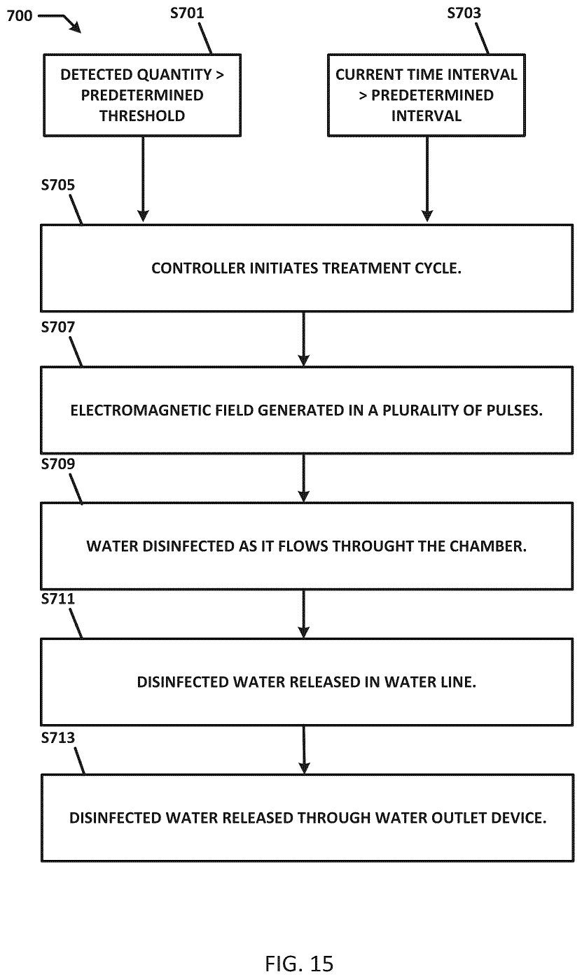

FIG. 15 illustrates a flow chart 700 for operating an electric field generator according to an exemplary embodiment of the present disclosure. The flow chart 700 illustrated in FIG. 15 may be employed by the electric field generator 10, apparatus 100, system 200, and/or system 300 of the present disclosure. Additional, different, or fewer acts may be provided.

At act S701, the controller 60 of the electric field generator 10 determines if a detected quantity of particles and/or microorganisms in a flow of water exceeds a predetermined threshold. The detected quantity of particles and/or microorganisms may be determined using sensor data collected by a sensor (e.g., sensor 120, first sensor 360, second sensor 370). If the detected quantity exceeds the predetermined threshold, the flow chart proceeds to act S705.

At act S703, the controller 60 of the electric field generator 10 determines if a current time interval since a last treatment cycle exceeds a predetermined time interval since a last treatment cycle. If the current time interval exceeds the predetermined time interval, the flow chart 700 proceeds to act S705.

In some examples, act S701 may performed and act S703 may not be performed. In other examples, act S703 may be performed and act S701 may not be performed. In yet other examples, act S701 and act S703 may be performed. Act S701 and act S703 may be performed concurrently.

At act S705, the controller 60 initiates a treatment cycle. In some examples, the controller 60 may initiate a treatment cycle by sending a signal or command to the generator circuit 20. In other examples, the controller 60 may initiate a treatment cycle by supplying current to the generator circuit 20.

At act S707, the electric field generator 10 generates an electromagnetic field via or using a plurality of pulses. The electric field generator may generate the electric field between the first electrode 40 and the second electrode 50. The frequency, duration, magnitude and/or number of electromagnetic pulses generated may be determined using a flow rate and/or volume of the flow of water.

At act S709, a flow of water is disinfected as it flows through the chamber 110, primary channel 150, first channel 320, or second channel 330. As the flow of water passes through the chamber 110, primary channel 150, the first channel 320, or second channel 330, the flow of water is subject to the plurality of pulses of the electromagnetic field occurring between the pair of electrodes. As the flow of water is subjected to the pulses of the electromagnetic field, electroporation occurs in the cell membrane of microorganisms in the flow of water, deactivating or killing the microorganisms and disinfecting the flow of water.

At act S711, the disinfected flow of water is released into a water line, for example the second water distribution conduit 570. The water line (e.g., second water distribution conduit 570) may be coupled (e.g., fluidly connected) to a water outlet device or plumbing fixture. The water outlet device is a device configure to dispense water. The water outlet device may be for example a faucet, a shower head, a toilet, or the like.

At act S713, the disinfected water is released through the water outlet device. In some examples, the chamber 110, primary channel 150, first channel 320, and/or second channel 330 may be directly connected to (e.g., in direct fluid communication with) or included (i.e., a part of) the water outlet device or plumbing fixture. For example, the chamber 110, primary channel 150, first channel 320, and/or second channel 330 may be a component of the water outlet device.

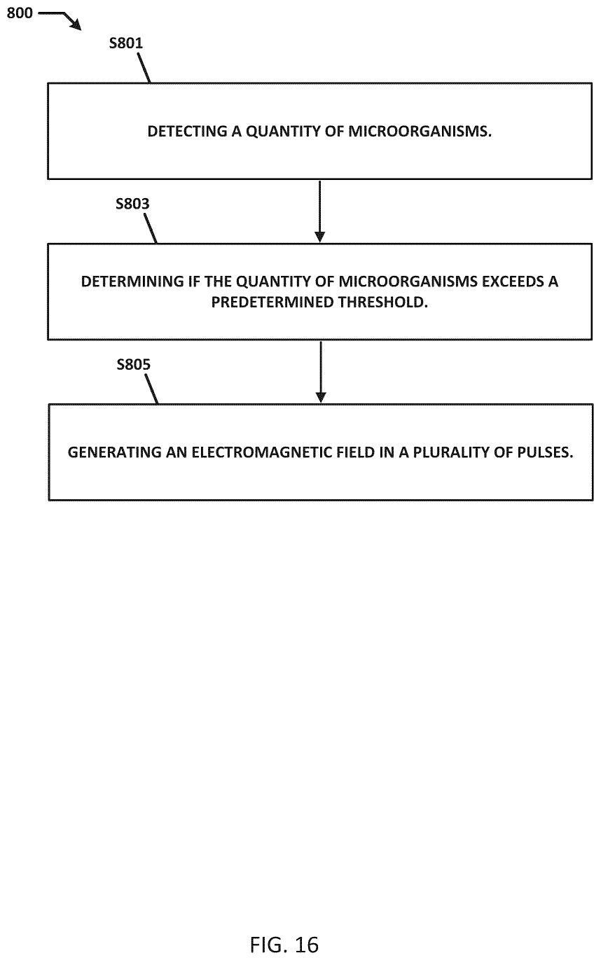

FIG. 16 illustrates another flow chart 800 for operating an electric field generator 10 according to an exemplary embodiment of the present disclosure. The flow chart 800 illustrated in FIG. 16 may be employed by the electric field generator 10, apparatus 100, system 200, and/or system 300 of the present disclosure. Additional, different, or fewer acts may be provided.

At act S810, a sensor (e.g., sensor 120, first sensor 360, second sensor 370) detects a quantity of particles and/or microorganisms in a flow of water. As described above, the sensor may be a turbidity sensor or a camera. The sensor collects sensor data indicative of the quantity of particles and/or microorganisms in the flow of water. The sensor 120 is connected to the controller 60 of the electric field generator and is configured to send the sensor data to the controller.

At act S803, the controller 60 determines if the detected quantity of particles and/or microorganisms exceeds a predetermined threshold of particles and/or microorganisms. The predetermined threshold of particles and/or microorganisms may vary. In some examples, the predetermined threshold may be 0 particles and/or microorganisms. In other examples, the predetermined threshold may correspond to a safe number of particles and/or microorganisms for consumption (e.g., drinking). If the detected quantity of particles and/or microorganisms exceeds the predetermined threshold, the flow chart 800 proceeds to act S805.

At act S805, the electric field generator 10 generates an electromagnetic field via a plurality of pulses. The electromagnetic field may be generated in the chamber 110, primary channel 150, first channel 320, and/or second channel 330, respectively, depending on the apparatus or system employing the flow chart 800. The intensity of the electric field, a duration of the magnetic field, and/or an interval between pulses of the electromagnetic field may be determined by the controller and/or a user input.

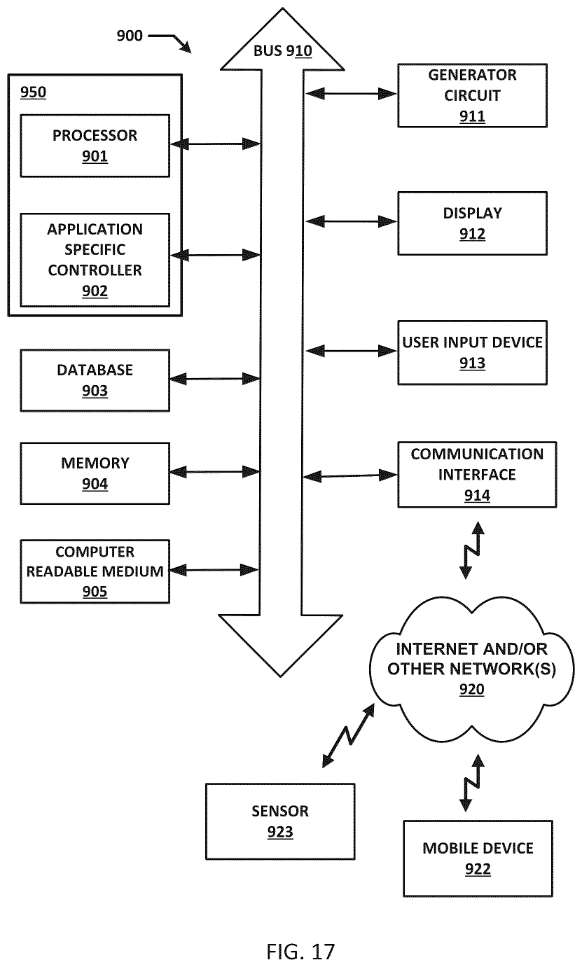

FIG. 17 illustrates an apparatus 900 for disinfecting water using pulsed electric fields according to an exemplary embodiment of the present disclosure. The apparatus 900 includes a bus 910 facilitating communication between a controller 950 that may be implemented by a processor 901 and/or application specific controller 902 and one or more components including a database 903, a memory 904, a computer readable medium 905, a generator circuit 911, display 912, a user input device 913, and a communication interface 914.

The contents of the database 903 may include an intensity of the electric field, a duration of the magnetic field, and/or an interval between pulses of the electromagnetic field. The database 903 may store intensities, durations, and/or intervals for a magnetic field depending on a flow rate of water through the chamber 110, primary channel 150, first channel 320, and/or second channel 330. In some examples, the database 903 may store an equation or equations for calculating an intensity, duration, and/or interval of a magnetic field based on a flow rate. The communication interface 914 may be connected to the network 920, which may be the internet. Additionally, the contents of the database may include one or more predetermined thresholds of particles and/or microorganisms.

In some embodiments, the network 920 may be connected to one or more mobile devices 922. The one or more mobile devices may be configured to send a signal to the communication interface 914 via the network 920. In some embodiments, the network may be in communication with one or more sensors 923. The one or more sensors 923 may be, for example, sensor 120, first sensor 360, or second sensor 370. The sensor 923 may be configured to send the sensor data to the communication interface 914 via the network 920. The communication interface 914 may include any operable connection. An operable connection may be one in which signals, physical connections and/or logical communications may be sent and/or received. An operable connection may include a physical interface, an electrical interface, and/or a data interface. The communication interface 914 provides for wireless and/or wired communications in any known or later developed format.

The controller 950 may receive the sensor data from the one or more sensors 923. The controller 950 may receive the predetermined threshold from the database 903. In some examples, the controller 950 may determine a quantity of particles and/or microorganisms in a flow of water using the sensor data. The controller 950 may compares the detected quantity of particles and/or microorganisms to the predetermined threshold of particles and/or microorganisms. If the detected quantity of particles and/or microorganisms exceeds the predetermined threshold, the controller may initiate a treatment cycle.

The memory 904 may be a volatile memory or a non-volatile memory. The memory 904 may include one or more read only memory (ROM), random access memory (RAM), a flash memory, an electronic erasable program read only memory (EEPROM), or other type of memory. The memory 904 may be removable from the apparatus 900, such as a secure digital (SD) memory card.

The memory 904 and/or the computer readable medium 905 may include a set of instructions that can be executed to cause the controller to perform any one or more of the methods or computer-based functions disclosed herein. For example, controller 950 may compare a detected quantity to a predetermined quantity. The controller may initiate a treatment cycle.

A user may initiate a treatment cycle, input a predetermined threshold, and/or set an intensity, duration, and/or interval of a magnetic field using the display 912 and/or user input device 913. The display 912 may comprise a screen and the user input device 913 may comprise one or more buttons on the apparatus 900. In some embodiments, the display 912 and user input device 913 may comprise a touch sensitive surface (i.e., a touch screen).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

When a component, element, device, or the like of the present disclosure is described as having a purpose or performing an operation, function, or the like, the component, device, or element should be considered herein as being “configured to” meet that purpose or to perform that operation or function.

What is claimed is:

1. An apparatus for disinfecting water using a pulsed electric field, the apparatus comprising:
a chamber configured to direct a flow of water;
a sensor disposed in the chamber configured to detect a quantity of microorganisms in the flow of water; and
an electric field generator configured to generate an electromagnetic field via a plurality of pulses, the electric field generator including a pair of electrodes disposed in the chamber and a controller configured to initiate generation of the electromagnetic field in response to the detected quantity of microorganisms exceeding a predetermined threshold.

2. The apparatus of claim 1, wherein the sensor is a camera configured to collect an image of the flow of water.

3. The apparatus of claim 1, wherein the sensor is a turbidity sensor.

4. The apparatus of claim 1, wherein the pair of electrodes is located downstream of the sensor in a direction of the flow of water.

5. The apparatus of claim 1, wherein the sensor is configured to detect a quantity of microorganisms in the water periodically after a predetermined interval of time.

6. The apparatus of claim 1, further comprising:
a first valve fluidly connected to the chamber and disposed at a first end of the chamber;
a second valve fluidly connected to the chamber and disposed at a second end of the chamber; and
a bypass conduit fluidly connected to the first valve and the second valve, wherein the first valve and the second valve are operable to divert the flow of water such that the flow of water passes through the bypass conduit and not a portion of the chamber including the sensor and the pair of electrodes.

7. The apparatus of claim 6, wherein the first valve is configured to control a flow rate or a volume of water passing therethrough.

8. The apparatus of claim 6, further comprising:
a third valve fluidly connected to and disposed between the first valve and the portion of the chamber including the sensor and the pair of electrodes; and
a backflow conduit fluidly connected to the third valve,
wherein the first valve is operable to control the flow of water to flow through the first valve to the bypass conduit, the second valve is operable to control the flow of water through the second valve to the portion of the chamber including the sensor and the pair of electrodes, and the third valve is operable to control the flow of water through the third valve to the backflow conduit.

9. The apparatus of claim 1, wherein the chamber, sensor, electric field generator, first valve, second valve, bypass line, and third valve are all disposed within a housing.

10. The apparatus of claim 1, wherein the electric field generator further includes:
a communication interface configured to receive a command for generating an electric field in the chamber in a plurality of pulses,
wherein the controller is configured to generate an electric field within the chamber in a plurality of pulses in response to the command.

11. A system for disinfecting water using pulsed electric fields, the system comprising:
a primary channel configured to direct a flow of water;
a sensor coupled to the primary channel and configured to detect a quantity of microorganisms in the flow of water; and
an electric field generator configured to generate an electromagnetic field via a plurality of pulses, the electric field generator including a pair of electrodes coupled to the primary channel and a controller, the controller configured to initiate generation of the electromagnetic field within the primary channel in response to the detected quantity of microorganisms exceeding a predetermined threshold.

12. The system of claim 11, wherein the sensor is a camera configured to collect an image inside the primary channel or a turbidity sensor.

13. The system of claim 11, wherein the pair of electrodes is located downstream of the sensor in a direction of flow of the water.

14. The system of claim 11, further comprising:
a faucet fluidly connected to the primary channel,
wherein the primary channel is configured to supply the flow of water to the faucet.

15. The system of claim 11, further comprising:
a first valve fluidly connected to the primary channel;
a second valve fluidly connected to the primary channel; and
a bypass channel fluidly connected to the first valve and the second valve,
wherein the sensor and the pair of electrodes are coupled to the primary channel between the first valve and the second valve, the first valve and the second valve being operable to divert the flow of water such that the flow of water passes through the bypass channel and does not pass through a portion of the primary channel including the sensor and the pair of electrodes.

16. The system of claim 15, further comprising:
a third valve fluidly connected to and disposed between the first valve and the portion of the primary channel including the sensor and the pair of electrodes; and
a backflow channel fluidly connected to the third valve,
wherein the first valve is operable to control the flow of water to flow through the first valve to the bypass channel, the second valve is operable to control the flow of water through the second valve into the portion of the primary channel including the sensor and the pair of electrodes, and the third valve is operable to control the flow of water through the third valve to the backflow channel.

17. A system for disinfecting water using pulsed electric fields, the system comprising:
a faucet;
a first channel fluidly connected to the faucet;
a second channel fluidly connected to the faucet;
a first sensor coupled to the first channel and configured to detect a quantity of microorganisms in a first flow of water through the first channel;
a second sensor coupled to the second channel and configured to detect a quantity of microorganisms in a second flow of water through the second channel; and
an electric field generator configured to generate an electromagnetic field via a plurality of pulses, the electric field generate including a first pair of electrodes coupled the first channel, a second pair of electrodes coupled the second channel, and a controller configured to initiate generation of a first electromagnetic field within the first channel in response to a first detected quantity of microorganisms exceeding a predetermined threshold and to initiate generation of a second electromagnetic field within the second channel in response to a second detected quantity of microorganisms exceeding the predetermined threshold.

18. The system of claim 17, wherein one of the first channel and the second channel is configured to supply hot water to the faucet and another of the first channel and the second channel is configured to supply cold water to the faucet.

19. The system of claim 17, wherein a portion of the first channel, a portion of the second channel, the first sensor, the second sensor, and the electric field generator are disposed within a housing.

20. The system of claim 17, wherein the first sensor and the second sensor are configured to detect a quantity of microorganisms in the first flow of water and the second flow of water, respectively, periodically after a predetermined interval of time.
